(19) United States
(12) Patent Application Publication
(10) Pub. No.: US 2016/0206506 A1
(43) Pub. Date: Jul. 21, 2016

(54) System, Method, and Apparatus for Providing a Massage

(71) Applicant: Tom Henkemans, St Pete Beach, FL (US)

(72) Inventor: Tom Henkemans, St Pete Beach, FL (US)

(21) Appl. No.: 14/972,997

(22) Filed: Dec. 17, 2015

Related U.S. Application Data
(60) Provisional application No. 62/103,780, filed on Jan. 15, 2015.

(51) Int. Cl. A61H 33/00

(52) U.S. Cl. CPC A61H 33/0087; A61H 2203/02

(57) ABSTRACT

A massage system includes a tub containing a fluid. The tub is covered by a surface on which a person receiving a massage lays. A pump receives the fluid from the tub and delivers the fluid to an input of at least two zone control valves. An output of each of the zone control valves is in fluid communication with a corresponding zone of water jets; each located within the tub and aimed at the surface. A controller selectively signals the zone control valves to open and close, thereby providing massage pressure in an area aimed at by water jets of the zone associated with an open zone control valve.

### CROSS-REFERENCE TO RELATED APPLICATION

This application claims the benefit of U.S. provisional application No. 62/103,780 filed on Jan. 15, 2015, the disclosure of which is incorporated by reference.

### FIELD

This invention relates to the field of therapy and more particularly to a system for providing a massage to a person.

### BACKGROUND

Many people receive various types of massages to make them feel better and/or to relieve aches and pains. Most typically, a massage is provided by a masseuse who is trained in the art of recognizing symptoms of such aches and providing appropriate pressure and movement to the areas of such pain. Such professional massages are often costly, in that, the trained masseuse must spend on the order of one half to one hour massaging the patient to help relieve the pain and comfort the patient. Such activity is often strenuous, making even a well-fit masseuse tired.

To provide a massage mechanically, systems have been marketed that use water jets to provide deep tissue simulation. Such systems, often called hydro-massage systems, employ a bed containing water on which the recipient of the massage lay. A movable orifice is then pressurized with water, aiming a jet of water onto a resilient surface upon which the recipient of the massage lay, thereby exerting pressure into the recipient of the massage, typically the back of the recipient of the massage. The movable orifice is slowly moved to provide pressure from the water jet beneath other parts of the recipient of the massage's body. Although such systems provide a massage to the recipient of the massage, implementing the movable orifice is often difficult, as it must be performed within the water of the bed. Furthermore, because of the nature of the movable orifice being submerged in water, the movable orifice is difficult to maintain and lubricate, leading to reliability issues that, once occur, the bed must be drained to access the movable orifice. Because of the mechanisms required to change positions of the movable orifice, such mechanical systems often emit unwanted noise that does not lead to relaxation in the patient using such systems. Furthermore, due to inertia and resistance of the water, it is difficult to move such orifices significant distances in short amounts of time, and, therefore, such systems are limited to sequential massages, starting at one end and slowly moving down the body of the recipient of the massage. Randomly locating the orifice is not possible with such a system and, therefore, one cannot program such a system to massage the lower area of the recipient of the massage, then the upper shoulder area, then the mid-section, etc.

What is needed is a system that will provide massages with greater reliability and lower noise.

### SUMMARY

In one embodiment, a massage system is disclosed including a tub containing a fluid and covered by a surface (e.g., a flexible surface such as rubber, leather, etc.). A pump receives the fluid from the tub and pressurizes the fluid. There are at least two zones, each having at least one water jet that is aimed at the flexible surface and at least two zone control valves. Each of the zone control valves is in fluid communication with the water jets of a corresponding one of the at least two zones and each of the zone control valves receives the pressurized fluid from the pump. Each of the zone control valves selectively delivers the pressurized fluid to the corresponding zone, thereby independently controlling delivery of the pressurized fluid to the at least one water jet in that zones. A controller signals the zone control valves to open to provide massage pressure in an area aimed at by the water jet(s) of that zone.

In another embodiment, a massage system is disclosed including a tub containing a fluid. The tub is covered by a surface on which a person receiving a massage lays. A pump receives the fluid from the tub and delivers the fluid to an input of at least two zone control valves. An output of each of the zone control valves is in fluid communication with a corresponding zone of water jets; each located within the tub and aimed at the surface. A controller selectively signals the zone control valves to open and close, thereby providing massage pressure in an area aimed at by water jets of the zone associated with an open zone control valve.

In another embodiment, a method of providing a message is disclosed including lying on a top of a surface that is suspended above a tub, the tub containing a fluid. A first zone is controlled to emit the fluid from a first set of water jet(s) aimed at a first underside location of the surface, then a second zone is controlled to emit the fluid from a second set of water jet(s) aimed at a second underside location of the surface. After the second zone is controlled to emit, the first zone is controlled to stop the fluid.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a cut-away view of a massage system showing the contents of the tub.

FIG. 2 illustrates a bottom plan view of the massage system.

FIG. 3 illustrates a top perspective view of the tub and contents with the cover removed.

FIG. 4 illustrates an elevation view of the massage system without side panels.

FIG. 5 illustrates a perspective view of the massage system showing the covering surfaces.

FIG. 6 illustrates a top perspective view of a water jet of the massage system without a cover.

FIG. 7 illustrates a top perspective view of the massage system with adjustable netting in place.

FIG. 8 illustrates a schematic view of the massage system.

FIG. 9 illustrates a view of a first typical control user interface of the massage system.

FIG. 10 illustrates a view of a second typical control user interface of the massage system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

To achieve the goals of the disclosed massage system, instead of moving an orifice (or jet) to massage different regions of the patient's body, a series of water jets are independently activated, thereby presenting water jets from the activated water jets. In doing such, the disclosed massage system is has the ability to randomly massage different areas of the patient's body with little or no delay between redirection of the massaging pressure. For example, the water jet(s) aimed at the patient's neck are activated, providing pressure to the patient's neck area, then, without delay, the water jet(s) aimed at the patient's lower back are activated, providing pressure to the patient's lower back, without waiting for a moving orifice to relocate from the neck area to the lower back area. Such changes to the pressure location are made without horizontal movement of a single orifice (or set of orifice), therefore improving reliability and flexibility while reducing noise.

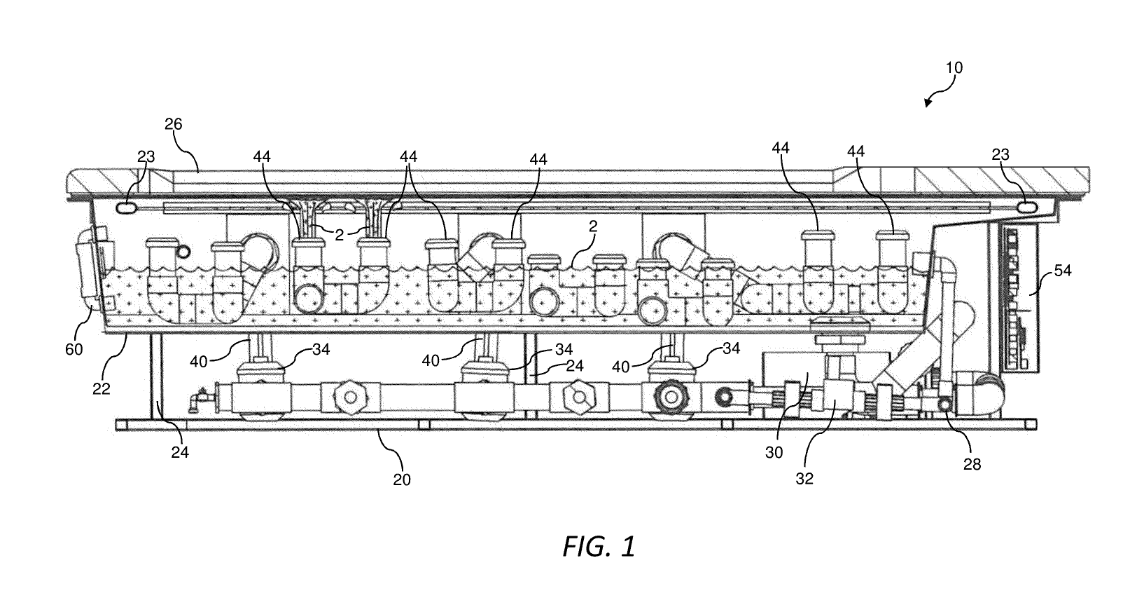

Referring to FIG. 1, an elevation view of a massage system 10 is shown. The massage system 10 includes a tub 22 or other fluid containment area (e.g. bladder, pool liner, etc.). In general, the fluid used is water 2, though any fluid is anticipated including water mixed with other chemicals such as bromine, chlorine, sodium chloride, etc. Throughout this description, the fluid will be referred to as water 2, though it is understood that any fluid is anticipated.

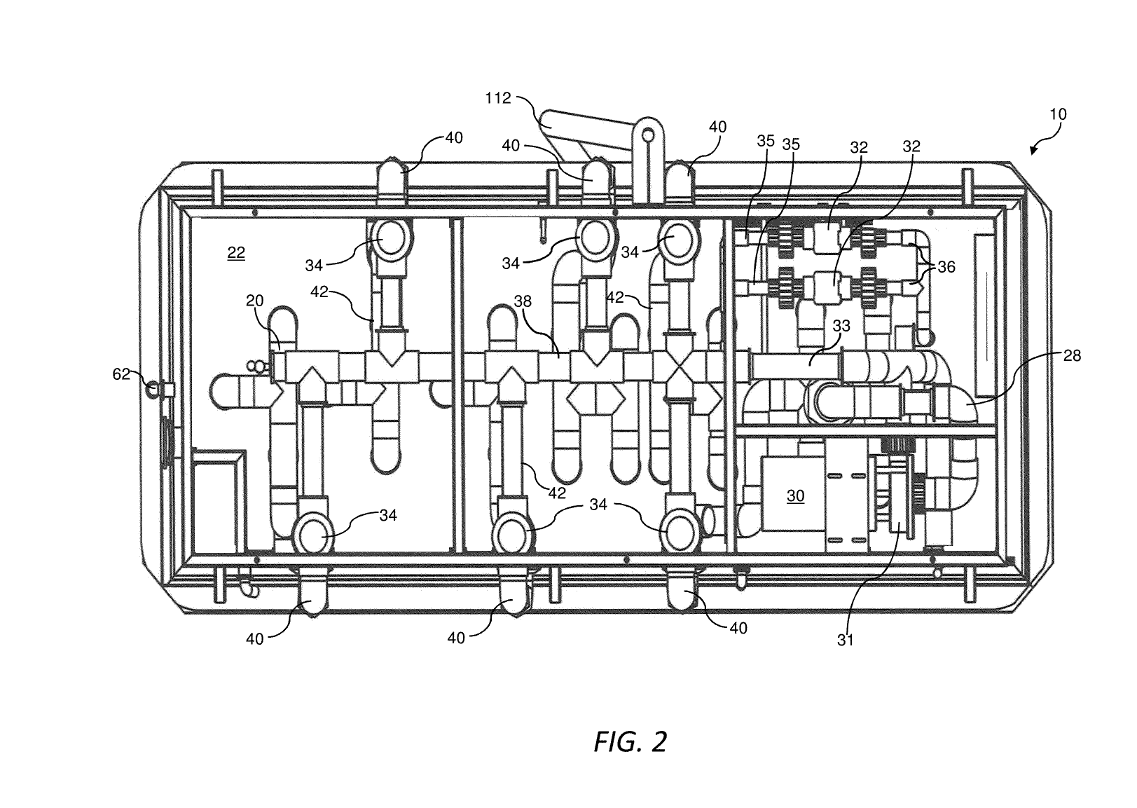

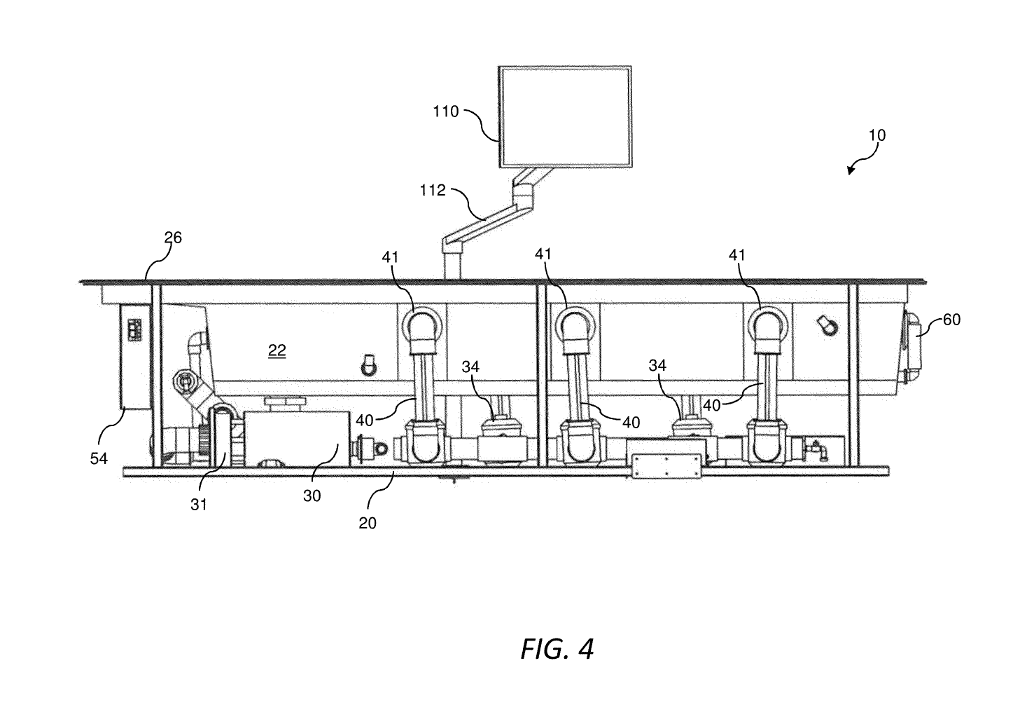

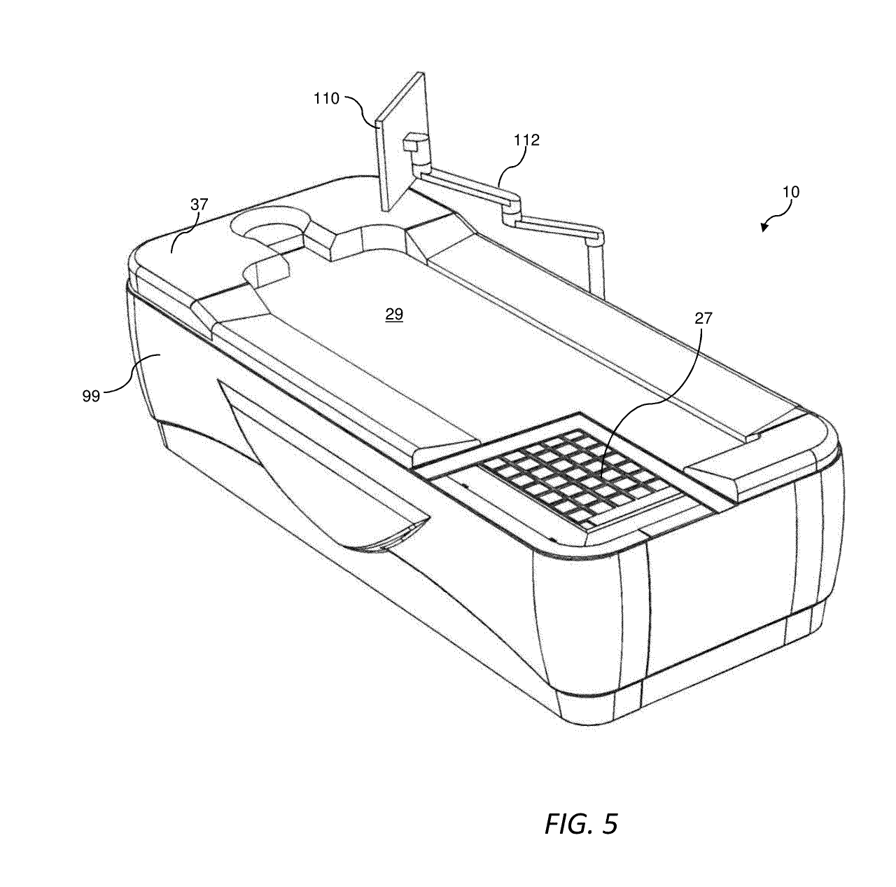

An upper frame 26 is supported above a lower frame 20 by posts 24, though any structural form is anticipated. From the side view, some of the plumbing is visible, as is a pump motor 30 (pump 31 is hidden, see FIGS. 2 and 4), control panel 54, heater 60, and valves 32/34, the configuration and operation of which will be described later. The drain/fill line 28 is used to provide fluid (e.g., water) into the tub 22 and/or to drain the fluid from the tub 22. A cooling radiator 50 (not shown) is optionally provided to cool the fluid when a cooler massage surface 29 (see FIG. 5 for details) is desired. Likewise, for heating of the fluid, an optional heater 60 is provided, for example, an immersion heating element 60. In some embodiments, one or more wheels (not shown) are affixed to the lower frame 20 to facilitate relocation of the massage system 10.

In a preferred embodiment, the surface 29 (e.g., the surface upon which a person receiving a massage lay) is supported by a sub-surface 27, for example, netting. The sub-surface 27 is preferably adjustable by increasing/decreasing tension using an adjustment mechanism 23. Both the surface 29 and sub-surface 27 are flexible for comfort and to conduct massage therapy from one or more jets 44 aimed at the sub-surface 27 and surface 29 to the person receiving the massage.

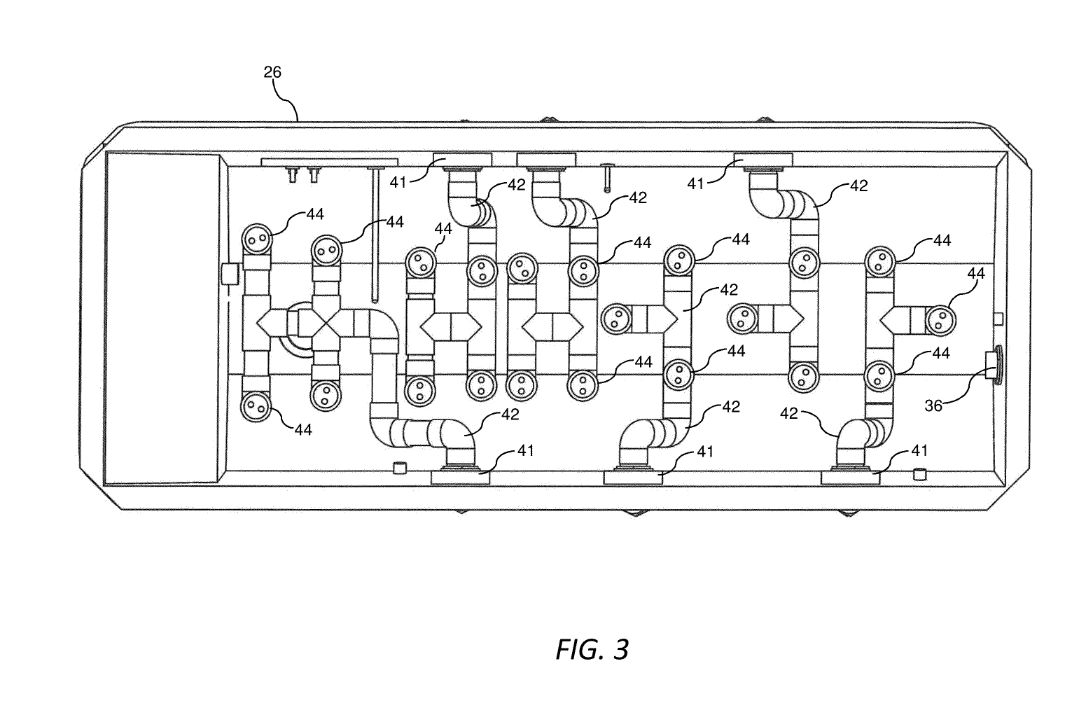

As will be described, water flows from the pump 31, under pressure, through a pressure control system having, for example, one or more pressure control valves 32 that, when open, direct water pressure from the pump 30 back into the tub 22 (e.g., bypassing jets 44). Water pressure from the pressure control system is routed to an input side of one or more zone control valves 34, each being associated with a zone of jets 44 (see FIGS. 2 and 3). The output side of each of the zone control valves 34 is fluidly connected to a respective zone of jets 44 through a connection tube 40.

Referring to FIGS. 2, a plan view of the massage system 10 is shown from the bottom. In this view, the bottom surface of the tub 22 is shown transparently, exposing the zone distribution tubes 42. Also, the exemplary pressure control system is shown, in this example having two pressure control valves 32. Pressurized fluid from the pump 31 operated by a pump motor 30 enters the pressure control system through a conduit 33 and flows to the pressure control valves 32 through a preferably smaller conduit 35. The pressurized fluid flows in parallel to the zone control valves 34 through preferably larger conduit 38. When greater pressure is desired, both pressure control valves 32 are closed, thereby directing all fluid (and pressure) from the pump 31 to the zone control valves 34 and when less pressure is desired, one or both pressure control valves 32 are opened to drain some of the pressure back into the tub 22 through pressure relief tubes 36. There is no limitation on the number of pressure control valves 32, providing any degree of pressure control. The example shown having two pressure control valves 32 provides three pressure settings, high (both pressure control valves 32 closed), medium (one pressure control valve 32 closed and one pressure control valve 32 open), and low (both pressure control valves 32 open).

Note that the pressure control valve 32 disclose one mechanism for controlling pressure, but many ways of controlling the pressure to the jets 44 are anticipated. For example, using a variable speed motor that operates the pump 31, or having one or more analog pressure control valves 32 that open proportional to the amount of pressure that is to be provided to the jets 44.

The zone control valves 34 are connected to zone distribution tubes 42 by riser tubes 40 that pass through seals 41 (see FIG. 3) into the tub 22. In FIG. 2, the zone distribution tubes 42 is visible (though partially hidden) and is shown from the opposite side in FIG. 3.

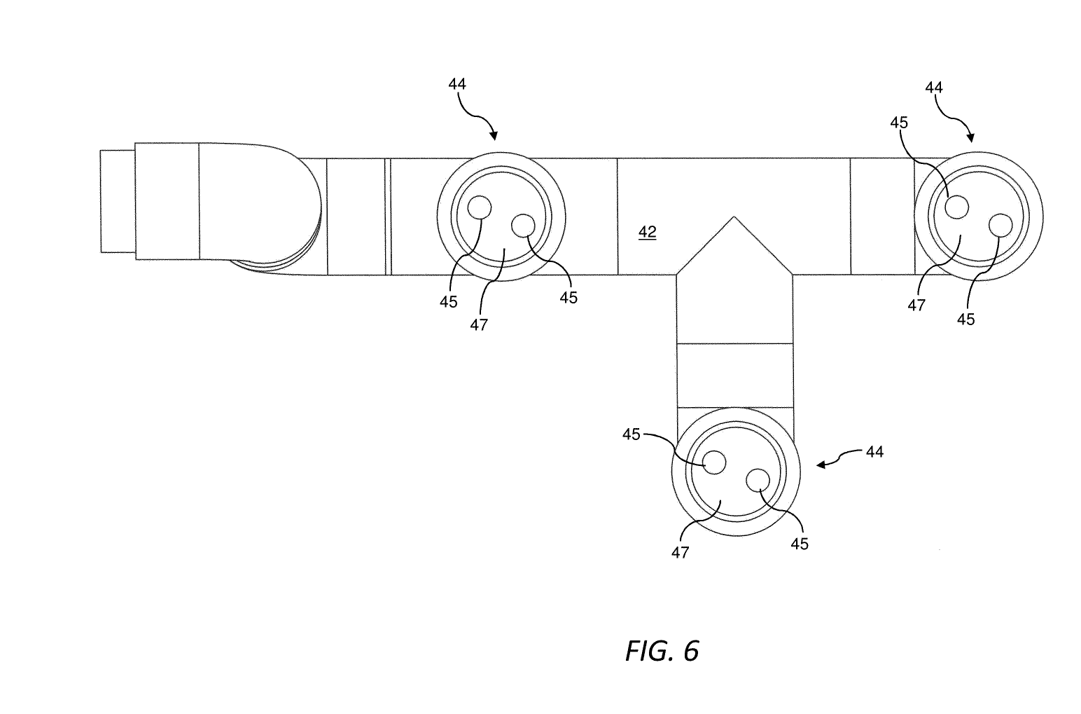

Referring to FIG. 3, a top perspective view of the massage system 10 without the surface 29 and sub-surface 27 is shown. In this view, the zone distribution tubes 42 receive fluid pressure from the zone riser tubes 40 when a corresponding zone control valve 34 is open. Each zone distribution tube 42 supports one or more jets 44, as shown, and any number of jets 44 per zone is anticipated, including on jet 44 per zone. Any type and arrangement of jets 44 is anticipated. In this example, each jet 44 has two offset orifices 45 in a jet disc 47, the jet disc 47 rotatable (see FIG. 6). As fluid flows out of the orifices 45, the jet disc 47 rotates. Again, any type and arrangement of jets 44 is anticipated, including those available for hot tubs and spas.

Also, in FIG. 3, the pressure relief tube 36 is shown terminating within the tub 22. As described above, when one or both pressure control valves 32 are open, pressure from the pump 31 is routed into the tub 22 to provide a lower pressure at the operating jets 44 (jets 44 associated with an open zone control valve 34), thereby allowing continuous operation of the pump motor 30 and reducing overload on the pump motor 30.

Referring to FIG. 4, a perspective view of plumbing of the massage system 10 without side panels 99 is shown. In this, typical positioning of the zone control valves 34 is shown. Although shown as typical sprinkler control valves 34, any type of valves are anticipated, for example, electrically controlled or pneumatically controlled valves 34.

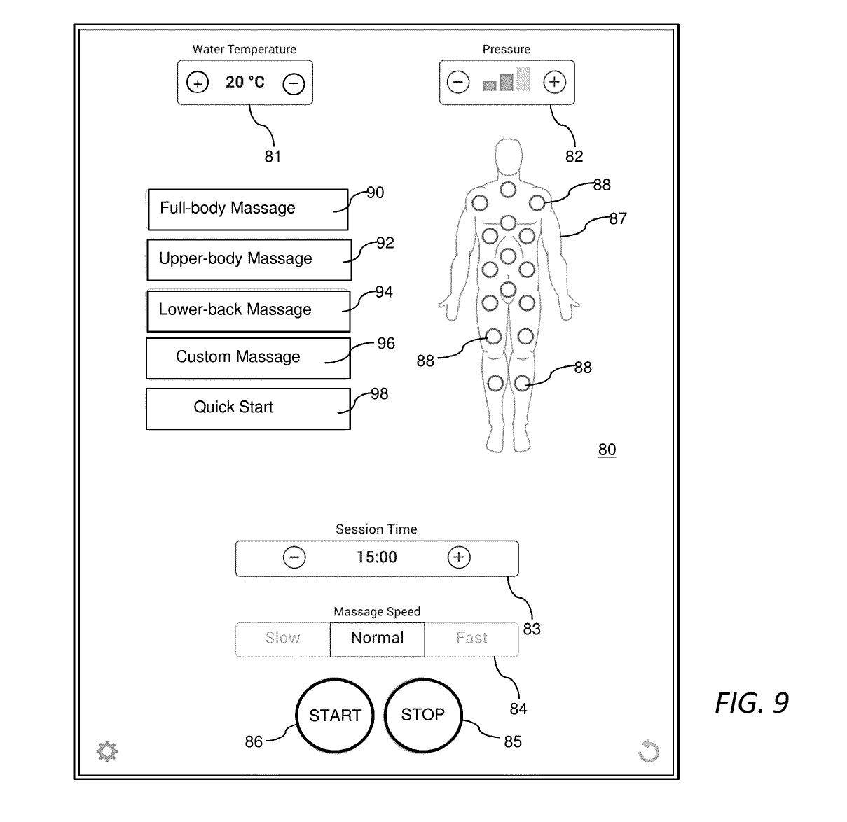

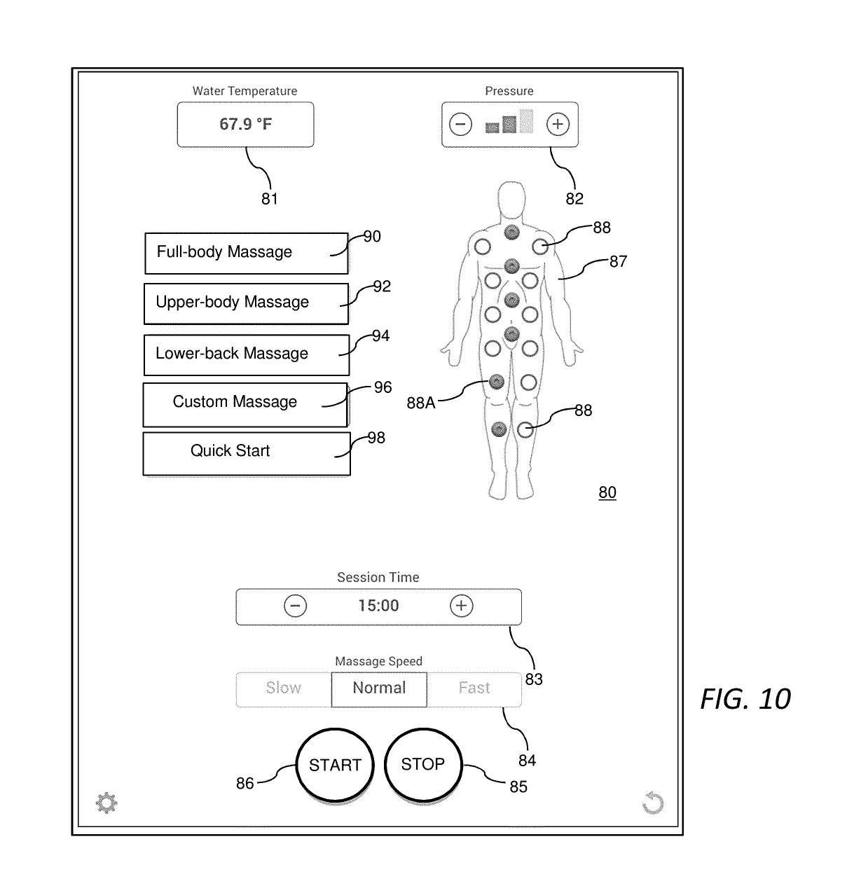

In some embodiments, a control panel 110 is provided from an adjustable arm 112, an exemplary operation of which is shown in FIGS. 9 and 10. In some embodiments, the control panel 110 has the ability to display content (e.g. video content) for the pleasure of a user of the massage system 10.

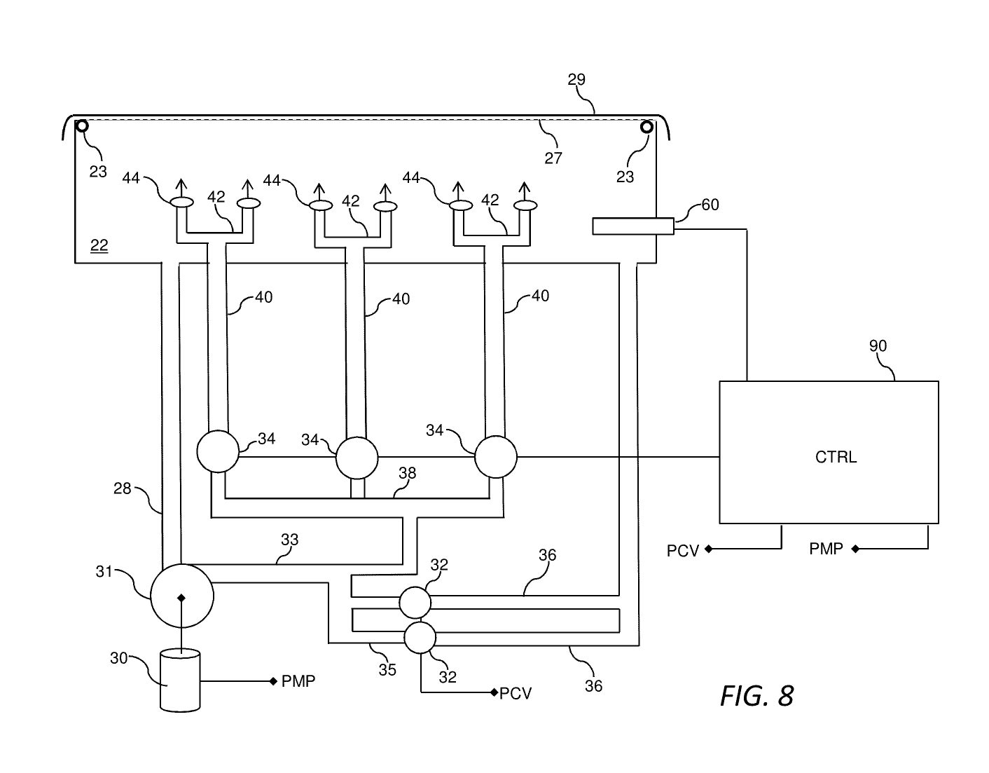

Referring to FIG. 5, a top plan view of the massage system 10 is shown with the surface 29 (see FIG. 8) partially cut-away. In this, the sub-surface 27 is partially shown. The sub-surface 27 is preferably adjustable to provide compensation for material changes over time and to provide compensation to various weights of users. As the sub-surface 27 stretches over time, additional tension is added to keep the sub-surface taught, thereby supporting the surface 29. It is anticipated that the surface 29 be any known surface 29, such as plastic, cloth, leather, etc. It is preferred that the surface 29 be cleaned after use. In FIG. 5, the side panels 99 and top panel 37 are shown, hiding the plumbing and tub 22. In some embodiments, a control panel 110 is provided from an adjustable arm 112, an exemplary operation of which is shown in FIGS. 9 and 10. In some embodiments, the control panel 110 has the ability to display content (e.g. video content) for the pleasure of a user of the massage system 10.

Referring to FIG. 6, a view of water jets 44 of the massage system 10 are shown. Again, any number, type, style, feature of water jet 44 is anticipated and the water jets 44 shown are for example purposes and in no way limit the disclosed system. In this example, there are three water jets 44 in one zone. The water jets 44 are fluidly connected and supported by the zone distribution tubes 42.

Each water jet 44 has two orifices 45 through which the fluid 2 (e.g. water) is expelled. The water jets 44 expel fluid 2 in a direction of the user that is resting on the surface 29 and supported by the sub-surface 27. Again, it is anticipated that there be any number of water jets 44, having any number of orifices 45 in any configuration and there is no limitation that all water jets 44 be the same. In this example, the orifices 45 are located on a rotatable disc 47 and the orifices are aimed slightly offset to each other such that, when water pressure flows through the orifices 45, this slight offset causes the rotatable disc 47 to rotate within the water jet 44, thereby covering a larger area of the user who is resting upon the surface 29.

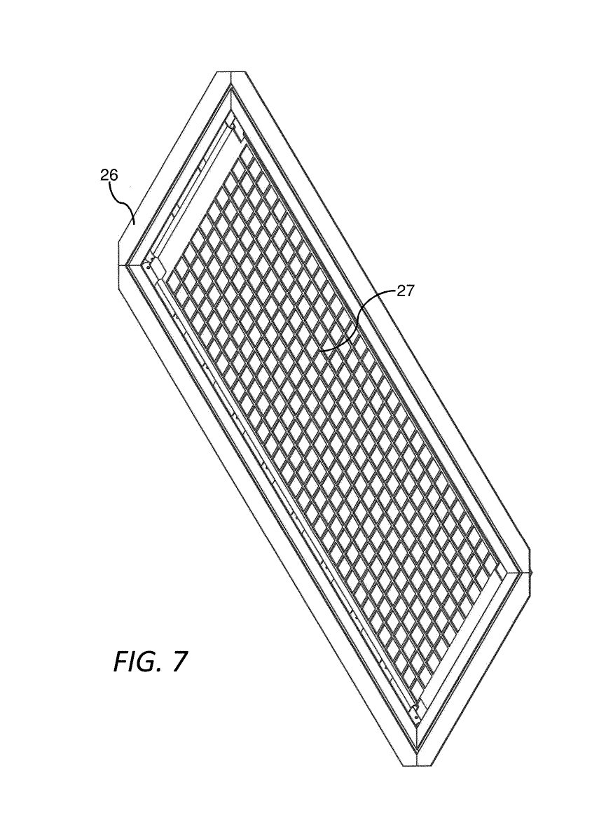

Referring to FIG. 7, a perspective view of the adjustable sub-surface 27 is shown with the surface 29 removed. In this view, the surface 29 is not shown to improve clarity of the sub-surface 27. The sub-surface 27 provides support to a person receiving a massage who is resting upon a surface 29 (not shown in FIG. 7) laid over the sub-surface 27. The sub-surface 27 provides support to counteract the weight of the person receiving a massage. During use, it is anticipated that the sub-surface 27 stretches out of shape slightly and, therefore, there are adjustments 23 to increase tension on the sub-surface 27. These adjustments are also anticipated to increase tension when the person receiving the massage is of greater weight. An example of an adjustment mechanism includes a tube (e.g., aluminum tube) inside the upper frame 26 of the massage system 10. The tube has through-bolts that adjust to pull the tube farther and tighter into the upper frame 26 and therefore tightening the sub-surface 27. The sub-surface 27 is affixed to the tube, thereby holding the sub-surface 27 in place. The through-bolts are tightened or loosened in order to adjust firmness.

Referring to FIG. 8, a schematic view of the massage system 10 is shown. In this, a controller 90 (e.g., within the control panel 54) includes logic or a processor that presents user controls (e.g. shown as a user interface in FIGS. 9 and 10). The controller 90 accepts user inputs, and controls various relays (e.g., solid-state or electro-mechanical relays), drivers, displays, etc., to control the massage system 10. In one embodiment, a processor presents user interfaces similar to those in FIGS. 9 and 10, accepts user inputs regarding heating, cooling, pressure, sequencing, etc. (e.g. through touch inputs), and then implements the massage based upon such inputs. To do such, in this example, the controller independently operates each of the zone control valves 34, each of the pressure control valves 32, the pump 31 (e.g. pump motor 30), the heating element 60, etc., through any driver mechanism known such as relays, solid-state relays, power transistors or FETs, etc.

To control pressure responsive to user programming/inputs, the controller 90 opens/closes one or both pressure control valves 32 (note that although two pressure control valves 32 are shown, any number are anticipated as is any other mechanism for controlling pressure including, but not limited to, controlling the speed of the motor driving the pump motor 30 and/or analog valves that open partially). Therefore, if the user requests high pressure, both pressure control valves 32 are closed by the controller 90 and all pressure from the pump is directed to the inputs of the zone control valves 34. If the user requests medium pressure, one pressure control valve 32 is opened and the other pressure control valve 32 is closed by the controller 90. Opening of one pressure control valve 32 directs some of the pressure from the pump 31 through the pressure relief tubes 36 back into the tub 22. If the user requests low pressure, both pressure control valves 32 are opened, directing more of the pressure from the pump 31 to through pressure relief tubes 36 back into the tub 22.

If the person receiving the massage desires pressure be directed to a certain area of the body (e.g. neck area), the controller opens a corresponding zone control valve 34, directing the selected pressure to the corresponding water jets 44 connected to the zone control valve 34 by the zone distribution tubes 42.

If the user requests heating, the controller initiates power to the heating element 60.

The sub-surface 27 is shown over the tub 22 with adjustable support tubes 23 that are tensioned by through-bolts (not shown) to increase/decrease tension on the sub-surface 27. The surface 29 above the sub-surface 27 limits provides additional comfort to the person receiving the massage, provides for cleaning, and isolates the fluids 2 within the tub 22.

Referring to FIGS. 9 and 10, views of typical user interfaces of the massage system 10 are shown. This user interface 80 is an example, as any user interface is anticipated, either based upon a computer user interface (e.g., as shown), a set of electrical and mechanical devices (e.g., switches, buttons, and indicators), or combinations of such.

In the examples shown, the interface 80 presents various features/settings that are controlled through, for example, touch or mouse operations. For example, invoking the “+” operation of the water temperature feature 81 will increase the power to the water heating element 60 and, hence, the temperature of the water in the tub 22. Invoking the “−” operation will decrease power to the water heating element 60 and, hence, the temperature. In such, the current temperature setting is shown within the feature 81 (20 degrees C. in this example). Through the various features, the user/patient is able to control the temperature setting 81, the pressure 82, which areas will receive massage therapy 88 (depicted on a form of a body 87), specific program settings 90/92/94/96/98, the duration of the operation 83, and the speed of operation 84. The speed of operation 84 controls how soon subsequent zones are changed, in that, at a fast speed, pressure transfers between zones faster than at a slow speed (e.g., one zone control valve 34 is closed and a different zone control valve 34 is opened).

In the examples shown, the user selects pre-programmed operations such as full-body massage 90, upper body massage 92, lower back massage 94, or quick start 98. If the user/patient desires a specific massage sequence or area of concentration, the user selects custom massage 96 then, as shown in FIG. 10, selects the specific areas of the body that the user wants to have massaged, as indicated by the darkened areas 88A.

Once programing of the massage system 10 is finished, the person receiving the massage (or operator) selects the start operation 86 to initiate the operation while the person receiving the massage lies upon the surface 29 to receive the massage. The massage will continue for the requested time (or indefinitely if that option is presented) or until the stop 85 is operated.

Through the disclosed hydraulic mechanisms, a massage is provided to a person receiving the massage lying on the surface 29 with limited noise, independent zone operation, and improved reliability. Any zone sequence is anticipated as well as concurrent operation of more than one zone, such not being possible with prior systems that mechanically moved jets.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A massage system comprising:
a tub containing a fluid, the tub covered by a surface;
a pump, the pump receiving the fluid from the tub and the pump creating a pressurized fluid;
at least two zones, each zone having at least one water jet aimed at the flexible surface;
at least two zone control valves, each of the zone control valves in fluid communication with the water jets of a corresponding one of the at least two zones, each of the zone control valves receiving the pressurized fluid and each of the zone control valves selectively delivering the pressurized fluid to the corresponding one of the at least two zones, thereby independently controlling delivery of the pressurized fluid to the at least one water jet in the corresponding one of the at least two zones; and
a controller, the controller signaling the corresponding one of the at least two zone control valves to open, thereby providing massage pressure in an area aimed at by the at least one water jet of the corresponding one of the at least two zones.

2. The massage system of claim 1, wherein each of the water jets comprises a rotating disc, the rotating disc having at least one orifice that is offset at an angle with respect to an outer surface of the rotating disc such that, when the pressurized fluid exits the at least one orifice, the rotating disc rotates by force of the pressurized fluid.

3. The massage system of claim 1, wherein the surface is supported by a sub-surface.

4. The massage system of claim 3, wherein a tension on the sub-surface is adjustable.

5. The massage system of claim 1, wherein the at least two zones is six zones and whereas the controller turns on a first zone control valve to deliver the pressurized fluid to a first one of the at least two zones before the controller turns off a second zone control valve to stop the pressurized fluid reaching a second one of the at least two zones.

6. The massage system of claim 5, wherein the first one of the at least two zones is not adjacent to the second one of the at least two zones.

7. The massage system of claim 1, further comprising at least one pressure control valve, an input of each pressure control valve in fluid communication with the pump, thereby receiving the pressurized fluid, and an output of each pressure control valve feeding back into the tub such that, when each of the pressure control valve is opened by the controller, a portion of the pressurized fluid is routed back into the tub, thereby reducing pressure at the jets.

8. The massage system of claim 1, further comprising a heater, the heater in fluid communication with the fluid for heating the fluid under control of the controller.

9. The massage system of claim 1, further comprising a chiller, the chiller in fluid communication with the fluid for chilling the fluid under control of the controller.

10. A massage system comprising:
a tub containing a fluid, the tub covered by a surface;
a pump, the pump receiving the fluid from the tub and the pump delivering the fluid to an input of at least two zone control valves, each output of the at least two zone control valves is in fluid communication with a corresponding zone of water jets, each of the water jets are located within the tub and each of the water jets are aimed at the surface; and
a controller, the controller signaling the at least two zone control valves to open and close, thereby providing massage pressure in an area aimed at by the at least one water jet of the zone associated with an open zone control valve of the at least two zone control valves.

11. The massage system of claim 10, wherein each of the water jets comprises a rotating disc, the rotating disc having at least one orifice that is offset at an angle with respect to an outer surface of the rotating disc such that, when the pressurized fluid exits the at least one orifice, the rotating disc rotates by force of the pressurized fluid.

12. The massage system of claim 10, wherein the surface is supported by a sub-surface.

13. The massage system of claim 12, wherein a tension on the sub-surface is adjustable.

14. The massage system of claim 10, further comprising at least one pressure control valve, an input of each pressure control valve in fluid communication with the pump, and an output of each pressure control valve feeding back into the tub such that, when each of the pressure control valve is opened by the controller, a portion of the pressurized fluid is routed back into the tub, thereby reducing pressure at the jets.

15. A method of providing a message comprising:
lying on a top of a surface, the surface above a tub containing a fluid;
controlling a first zone to emit the fluid from a first set of water jet(s) aimed at a first underside location of the surface;
next, controlling a second zone to emit the fluid from a second set of water jet(s) aimed at a second, different underside location of the surface;
next, controlling the first zone to stop the fluid.

16. The method of claim 15, further comprising:
controlling a pressure control valve to open, thereby reducing a pressure of the fluid emitted from the first set of water jet(s) and/or the second set of water jet(s);

17. The method of claim 15, wherein the first zone is controlled by a first zone control valve connected between a pump and the first set of water jet(s) and the second zone is controlled by a second zone control valve connected between the pump and the first set of water jet(s), an input of the pump receives the fluid from the tub.

18. The method of claim 15, wherein the surface is supported by a sub-surface.

19. The method of claim 18, further comprising the step of adjusting a tension of the sub-surface to tighten the sub-surface and surface.
